(19) United States
(12) Patent Application Publication
(10) Pub. No.: US 2018/0281527 A1
(43) Pub. Date: Oct. 4, 2018

(54) PNEUMATIC VEHICLE TIRE

(71) Applicant: Continental Reifen Deutschland GmbH, Hannover (DE)

(72) Inventors: Andreas Haertwig, Hannover (DE); Chun Yi Yeo, Hannover (DE); Florian Kristen, Hannover (DE)

(21) Appl. No.: 15/997,372

(22) Filed: Jun. 4, 2018

Related U.S. Application Data
(63) Continuation of application No. PCT/EP2016/071742, filed on Sep. 15, 2016.

(30) Foreign Application Priority Data
Dec. 9, 2015 (DE) 10 2015 224 713.9

(51) Int. Cl. B60C 11/03; B60C 11/13

(52) U.S. Cl. CPC B60C 11/0309; B60C 11/0302; B60C 2200/065; B60C 2011/0365; B60C 2011/0367; B60C 11/1323

(57) ABSTRACT

A tread profile is divided into two parts in the axial direction (A) of the tire and has two axially adjacent profile block rows, each of which is formed from profile block elements that are arranged one behind the other over the circumference of the tire and are separated from one another by inclined grooves. The inclined grooves of one profile block row are configured to slope along the axial extent of the inclined grooves through the profile block row, starting from the other profile block row, such that the main direction of extent of the inclined grooves forms an angle α of inclination relative to the axial direction (A). The inclined grooves of one profile block row have a direction of inclination which is oriented oppositely to that of the inclined grooves of the other profile block row when seen in the circumferential direction (U).

### CROSS REFERENCE TO RELATED APPLICATIONS

This application is a continuation application of international patent application PCT/EP2016/071742, filed Sep. 15, 2016, designating the United States and claiming priority from German application 10 2015 224 713.9, filed Dec. 9, 2015, and the entire content of both applications is incorporated herein by reference.

### FIELD OF THE INVENTION

The invention relates to a rotationally directional tread profile of a commercial vehicle, the profile being divided into two parts in the axial direction A of the tire, having two axially adjacent profile block rows, each of which is formed from profile block elements that are arranged one behind the other over the circumference of the tire and are separated from one another by diagonal grooves and thereby form a respective axial part of the extent of the tread profile, wherein the diagonal grooves of one profile block row are configured so as to slope along the axial extent of the diagonal grooves through the profile block row, starting from the other profile block row, such that the main direction of extent of the diagonal grooves forms an angle of inclination a relative to the axial direction A.

### BACKGROUND OF THE INVENTION

Pneumatic vehicle tires of the kind described above are known.

Commercial vehicle tires for “construction” applications, for example, on concrete mixer trucks or tipper trucks for construction sites, should make possible highly durable profiles and good traction properties, even on loose underlying surfaces of the kind often found on construction sites. To achieve this, there is a known practice of forming such commercial vehicle tires with a particularly coarsely studded block profile having coarse, rigid profile block elements which are separated only by transverse grooves. This enables the profile to really dig in on loose underlying surfaces and thus allows good traction. On a conventional, well-paved road surface, on which direct surface contact between the radially outer surface of the profile block elements and the road surface is crucial for traction, traction through digging in is not possible. On such well-paved road surfaces, the coarsely studded profiles, in which the block elements are separated only by transverse grooves, have increased sawtooth effects since the edges, formed by the transverse grooves, of the stiff profile block elements are subject to different loads and wear in the leading and trailing areas. At the same time, the increased sawtooth effect leads to increased tire rolling noise and rough running.

U.S. Pat. No. 5,127,455 discloses the formation of a rotationally nondirectional commercial vehicle tire having profile block elements which are delimited by diagonally oriented grooves. This rotationally nondirectional tire is formed in each of the tire shoulder regions with profile block rows on each side of a central circumferential rib. Here, the diagonal grooves in the profile block rows are formed with segments at different angles of inclination to the axial direction A along the axial extent of the diagonal grooves, wherein the angle of inclination of the individual segments of a single individual diagonal groove is also configured with an alternating direction of inclination. The circumferentially extended tips of the profile block element flanks within the profile block elements, the tips being formed over the axial extent of the profile block rows formed change in direction of the direction of inclination, further promote the occurrence of sawtooth effects. The transmission of driving forces is reduced. The change in direction does not allow the formation of a rotationally directional V profile.

### SUMMARY OF THE INVENTION

It is an object of the invention to provide a commercial vehicle tire of this kind with good dig-in performance on loose underlying surfaces and improved suitability for road use.

According to the invention, the object is achieved by the formation of a rotationally directional tread profile of a commercial vehicle, the profile being divided into two parts in the axial direction A of the tire, having two axially adjacent profile block rows, each of which is formed from profile block elements that are arranged one behind the other over the circumference of the tire and are separated from one another by diagonal grooves and thereby form a respective axial part of the extent of the tread profile, wherein the diagonal grooves of one profile block row are configured so as to slope along the axial extent of the diagonal grooves through the profile block row, starting from the other profile block row, such that the main direction of extent of the diagonal grooves forms an angle of inclination a relative to the axial direction A. According to a feature of the invention, the diagonal grooves of one profile block row have a direction of inclination which is oriented oppositely to that of the diagonal grooves of the other profile block row when seen in the circumferential direction U, and the angle of inclination α of the diagonal grooves of each profile block row is formed such that 25°≤α≤35°, and in which the diagonal grooves of one profile block row are formed along the axial extent of the diagonal grooves through the respective profile block row, starting from the other profile block row, such that first and second segments are formed which are arranged one behind the other in an alternating manner, wherein, along the extent of the diagonal grooves, the diagonal grooves each form an angle of inclination γ, where 10°≤γ≤α, with respect to the axial direction A in the first segments and an angle of inclination β, where α≤β≤60°, with respect to the axial direction A in the second segments.

This embodiment makes it possible to implement a rotationally directional commercial vehicle profile with a V-shaped structure for optimum transmission of driving force. In this case, the configuration of the diagonal grooves with an angle of inclination α furthermore makes it a simple matter to implement the coarsely studded block profile desired for use on loose underlying surfaces. Here, the embodiment with alternating segments makes it possible to form the grooves with alternating slope segments without a change of orientation within the profile block rows, thereby making it possible to effectively implement high power transmission on a loose surface and on a road surface. Here, the alternating sequence of the first and second segments makes it possible to reduce the sawtooth effect. Thus, the alternating use of such commercial vehicle tires both on loose underlying surfaces and on road surfaces combined with good durability and high traction properties can be implemented in a simple manner.

The embodiment of a vehicle tire is especially advantageous, wherein the beginning of extent of the diagonal grooves of the first profile block row, the beginning being directed toward the second profile block row, is in each case arranged offset in the circumferential direction with respect to the position of the beginning of extent of the diagonal grooves of the second profile block row, the beginning being directed toward the first profile block row. This is a simple way of enabling a distribution of lateral openings in the profile with which optimum traction can be reliably implemented by means of lateral openings in any profile segment in the circumferential direction.

An embodiment of a vehicle tire is especially advantageous, wherein the profile block elements of the first profile block row are each delimited in the circumferential direction U by two successive diagonal grooves of the first profile block row and, between the two diagonal grooves, are delimited in the direction of the second profile block row by a segment of a diagonal groove of the second profile block row, and wherein the profile block elements of the second profile block row are each delimited in the circumferential direction U by two successive diagonal grooves of the second profile block row and, between the two diagonal grooves, are delimited in the direction of the first profile block row by a segment of a diagonal groove of the first profile block row. By virtue of the separation formed in this way between the block rows while achieving an overlap in the center of the tire, particularly good traction on loose underlying surfaces can be implemented in a simple and reliable manner while maintaining sufficient tread material in the center of the tire for good abrasion properties in road use.

An embodiment of a vehicle tire is especially advantageous, wherein the diagonal grooves of one profile block row are each formed with a first segment at the beginning of extent of the diagonal grooves which faces the other profile block row. As a result, it is precisely in the region of the axial center of the profile which is of particular importance for the transmission of high traction forces during driving is also configured in an optimized way for transmission.

The embodiment of a vehicle tire is especially advantageous, wherein the diagonal grooves of one profile block row are each formed with a first segment at that end of extent of the diagonal grooves which faces away from the other profile block row, the end being formed in a tire shoulder. As a result, it is precisely in the region of the tire shoulder which is of particular importance for the transmission of high traction forces during braking is also configured in a further optimized way for the transmission of high traction forces.

The embodiment of a vehicle tire is especially advantageous, wherein the diagonal grooves have an uneven number of segments formed from first and second segments along the extent of the diagonal grooves. Optimization of tire noise is made possible by this embodiment.

The embodiment of a vehicle tire is especially advantageous, wherein the diagonal grooves have four to eight segments formed from first and second segments along the extent of the diagonal grooves. This embodiment allows an optimum balance between good traction and low tire noise.

The embodiment of a vehicle tire is especially advantageous, wherein the profile block elements of one profile block row are each extended axially inward, beyond the equatorial plane Ä-Ä of the tire, toward the other profile block row in the axial direction A, in each case starting from the tire shoulder, and end there. It is thereby possible to further improve traction, precisely in the region of the center of the tire, by means of sufficiently laterally extended openings.

### BRIEF DESCRIPTION OF THE DRAWINGS

The invention will now be described with reference to the drawings wherein:

FIG. 1 shows a segment of the circumference of a tread profile of a commercial vehicle tire for “construction” applications in plan view;

FIG. 2 shows the tread profile of FIG. 1 in a sectional view as per section II-II in FIG. 1;

FIG. 3 shows the tread profile of a commercial vehicle tire from FIG. 1 in an alternative embodiment; and,

FIG. 4 shows the tread profile of FIG. 3 in a sectional view as per section IV-IV in FIG. 3.

### DESCRIPTION OF THE PREFERRED EMBODIMENTS OF THE INVENTION

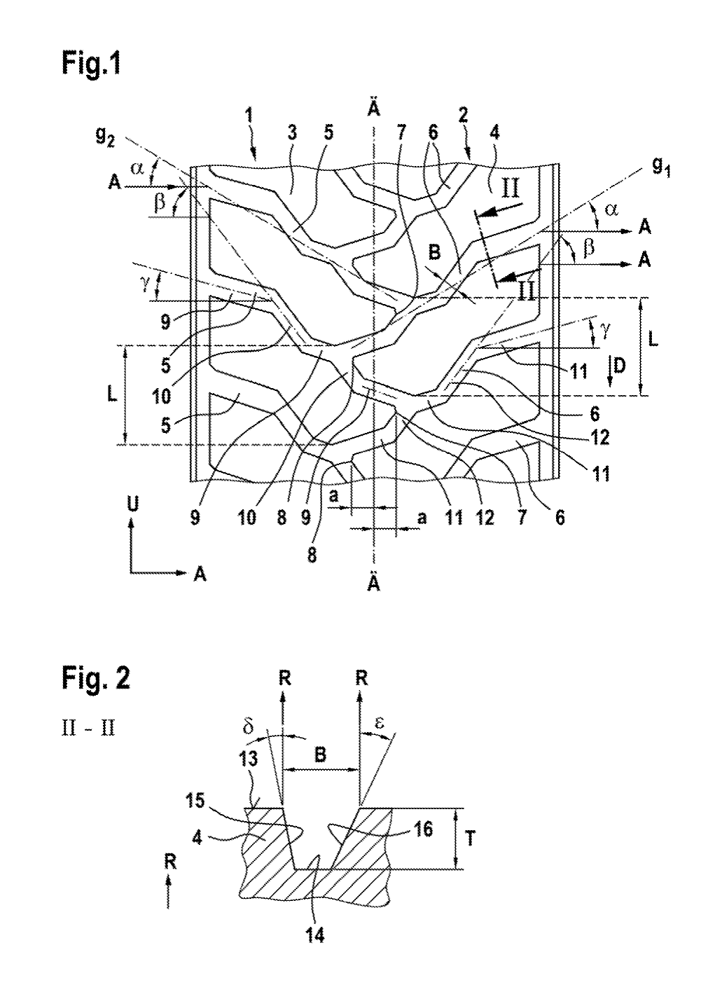

FIGS. 1 and 2 show a pneumatic commercial vehicle tire for use on loose underlying surfaces and on firm road surfaces, having a tread profile which is divided into two in the axial direction A of the pneumatic vehicle tire. The equatorial plane Ä-Ä of the pneumatic vehicle tire is depicted in FIG. 1. As can be seen in FIG. 1, the tread profile is divided axially into two by the formation of two profile block rows 1 and 2, which are arranged adjacent to one another in the axial direction A of the pneumatic vehicle tire. In a known manner, profile block row 1 is in this case formed, in the circumferential direction U of the pneumatic vehicle tire, from profile block elements 3 arranged in a manner distributed over the circumference and spaced apart from one another by diagonal grooves 5. In a known manner, profile block row 2 is formed, in the circumferential direction U, from profile block elements 4, which are arranged in a manner distributed one behind the other over the circumference of the pneumatic vehicle tire and which are separated from one another in each case by diagonal grooves 6. In the circumferential direction U of the pneumatic vehicle tire, each profile block element 3 of profile block row 1 is in this case delimited by a diagonal groove 5 in each of the two orientations of the circumferential direction U. Likewise, each profile block element 4 of profile block row 2 is delimited by a diagonal groove 6 in each of the two orientations of the circumferential direction U. As illustrated in FIG. 2 by the example of profile block row 2, the profile block elements 4 and 3 are delimited outward in the radial direction R of the pneumatic vehicle tire in each case by a radially outer surface 13, which forms the road contact surface.

The profile block elements 4 of profile block row 2 extend in the axial direction A of the pneumatic vehicle tire in a direction toward profile block row 1 as far as a tip 8, which is formed on the respective profile block element 4 at a distance a from the equatorial plane Ä-Ä. The profile block elements 3 of profile block row 1 extend in the axial direction A in a direction toward profile block row 2 as far as a tip 7, which is formed on the respective profile block element 3 at a distance a from the equatorial plane Ä-Ä. As can be seen in FIG. 1, the profile block element 4 of profile block row 2 in each case extends in the axial direction A toward profile block row 1, between the tips 7 of two profile block elements 3 arranged one behind the other in the circumferential direction, beyond the equatorial plane Ä-Ä as far as the tip 8 of profile block element 4. Likewise, profile block elements 3 extend in the axial direction A toward profile block row 2, in each case between the tips 8 of two profile block elements 4 of profile block row 2 which are adjacent to one another in the circumferential direction U, beyond the equatorial plane Ä-Ä as far as the tip 7 of profile block elements 3. Thus, the profile block elements 4 and 3 are configured so that the axial extent thereof overlaps in the axial direction A by the amount (2a).

As can be seen in FIG. 1, the diagonal grooves 5 in this case extend outward in the axial direction A from the axial position of the adjoining tip 7 of profile block element 3, through profile block row 1, beyond the equatorial plane Ä-Ä, into the tire shoulder—illustrated on the left in FIG. 1—as far as the flank delimiting profile block row 1—and thus the tread profile—axially toward the outside.

As can be seen in FIG. 1, diagonal grooves 6 in this case similarly extend outward in the axial direction A from the axial position of the adjoining tip 8 of profile block element 4, through profile block row 2, beyond the equatorial plane Ä-Ä, as far as the flank delimiting profile block row 2 and thus the tread profile in the tire shoulder—illustrated on the right in FIG. 1—axially toward the outside.

In this case, the diagonal grooves 5 are configured to extend outward in the axial direction A from the axial position of the tips 7 of the adjoining profile block element 3 as far as the flank of the profile block elements 3—in the tire shoulder illustrated on the left in FIG. 1—which delimits the profile block elements 3 and thus profile block row 1 and the tread profile in the axial direction A to the from the end of extent facing away from the equatorial plane Ä-Ä and thus from profile block row 2, and, in this case, they extend with a main direction of extent along a straight line g₂ which encloses an angle of inclination a with respect to the axial direction A. Likewise, the diagonal grooves 6 are configured to extend outward in the axial direction from the axial position of the tip 8 of the adjoining profile block element 4 as far as the flank of the profile block elements 4—in the tire shoulder illustrated on the right in FIG. 1—which delimits the profile block elements 4 and thus profile block row 2 and the tread profile in the axial direction A to the from the end of extent facing away from the equatorial plane Ä-Ä and thus from profile block row 1, and, in this case, they extend with a main direction of extent along a straight line g₁ which encloses an angle of inclination a with respect to the axial direction A. The angle of inclination α is in each case configured such that 25°≤α≤35°, for example, such that α=30°. Here, the main direction of extent g₁ is in each case the straight line g₁ which connects the points of the center line of diagonal groove 6 which are measured in the radially outer surface 13 in the axial position of the tip 8 and in the axial position of the flank delimiting the profile block elements 4 toward the outside. Likewise, the main direction of extent g₂ is the straight line which connects the points of the center line of diagonal groove 5 which are measured in the radially outer surface 13 in the axial position of the tip 7 and in the axial position of the flank delimiting the profile block elements 3 toward the outside.

As can be seen in FIG. 1, the main direction of extent g₁ of profile block row 2 and g₂ of the profile block rows 1 slope in opposite directions to one another along their extent in the circumferential direction U of the pneumatic vehicle tire. The diagonal grooves 5 and 6 thereby form a V-shaped profile.

As can be seen in FIG. 1, the diagonal grooves 5 are formed from first segments 9 and second segments 10 arranged one behind the other in an alternating sequence along the axial extent of the grooves, starting from the axial position of the tip 7 to the end of extent of the grooves—formed in the left-hand shoulder in FIG. 1. Likewise, the diagonal grooves 6 are formed from first segments 11 and second segments 12 arranged one behind the other in an alternating sequence along the axial extent of the grooves, starting from the axial position of the tip 8 to the end of extent of the grooves—formed in the right-hand shoulder in FIG. 1.

Each diagonal groove 5 is formed such that, along its extent, it slopes in such a way that it encloses an angle of inclination y with respect to the axial direction A of the pneumatic vehicle tire in the first segment 9 and encloses an angle of inclination β with respect to the axial direction A of the pneumatic vehicle tire in the second segment 10. The extent and thus the angles of inclination β and γ are in each case measured in the radially outer surface 13, along the center line of the respective diagonal groove 5. In the first segment 9 and in the second segment 10, the inclination chosen is in each case configured with the same slope orientation as the main direction of extent g₂ of diagonal groove 5.

Similarly, each diagonal groove 6 is formed such that, along its extent, it slopes in such a way that it encloses an angle of inclination γ with respect to the axial direction A of the pneumatic vehicle tire in the first segment 11 and encloses an angle of inclination β with respect to the axial direction A of the pneumatic vehicle tire in the second segment 12. The extent and thus the angles of inclination β and γ are in each case measured in the radially outer surface 13, along the center line of the respective diagonal groove 6. In the first segment 11 and in the second segment 12, the inclination chosen is in each case configured with the same slope orientation as the main direction of extent g₁ of diagonal groove 6.

Here, the angles of inclination γ and β chosen are 10°≤γ<α and α<β≤60°. For example, the angle chosen for γ is γ=15° and that for β is β=50°.

As can be seen in FIG. 1, the diagonal groove 6 is in each case formed with a first segment 11 between the axial position of the tips 8 and 7 at the beginning of extent of the diagonal groove. Likewise, diagonal groove 5 is in each case formed with a first segment 9 between the axial position of the points 7 and 8 at the beginning of extent of the diagonal groove. As can be seen in FIG. 1, the diagonal grooves 5 and 6 are likewise each formed with a first segment 11 and 9, respectively, at the end of extent of the grooves, which is formed in the region of the tire shoulder. Along the extent of the diagonal grooves, the diagonal grooves 5 and 6 are thus formed with an uneven number of first and second segments arranged one behind the other and each begin and end with a first segment 11 or 9, respectively.

In the embodiment shown, the transverse grooves 5 and 6 are each formed with five segments arranged one behind the other in the axial direction A.

In FIG. 1, the envisaged direction of rotation D of the vehicle tire during forward travel is indicated by an arrow.

The first segment 11, which is formed between the axial positions of the tips 7 and 8, and the directly adjoining second segment 12 of diagonal groove 6 each form, with their groove wall arranged ahead of diagonal groove 6 in the direction of rotation D, that flank of the profile block element 3 adjoining in the region of the extent of diagonal groove 6, between the tips 7 and 8, which faces diagonal groove 6 and, with their groove wall which follows on in the direction of rotation D, form that flank of the profile block element 4 delimited by diagonal groove 6 which faces diagonal groove 6. Outside the axial segments formed between the tips 7 and 8, the two groove walls of the diagonal grooves 6 each form the flanks of the two profile block elements 4 delimited by diagonal groove 6, which flanks are directed toward the respective diagonal groove 6 in the circumferential direction U.

The first segment 9, which is formed between the axial positions of the tips 7 and 8, and the directly adjoining second segment 10 of diagonal groove 5 each form, with their groove wall arranged ahead of diagonal groove 5 in the direction of rotation D, that flank of the profile block element 4 adjoining in the region of the extent of diagonal groove 5, between the tips 7 and 8, which faces diagonal groove 5 and, with their groove wall which follows on in the direction of rotation D, form that flank of the profile block element 3 delimited by diagonal groove 5 which faces diagonal groove 5. Outside the axial segments formed between the tips 7 and 8, the two groove walls of the diagonal grooves 5 each form the flanks of the two profile block elements 3 delimited by diagonal groove 5, which flanks are directed toward the respective diagonal groove 5 in the circumferential direction U.

As illustrated in FIG. 2 using the example of a diagonal groove 6, the diagonal grooves 5 and 6 are each formed with a profile depth T, measured in the radial direction R, which, starting from the radially outer surface 13, extends as far as the groove base 14 delimiting the respective diagonal groove 5 or 6 in the radially inward direction. The profile depth T is configured such that 12 mm≤T≤25 mm, for example such that T=19 mm.

The diagonal grooves 5 and 6 are formed with a groove width B of 10 mm≤B≤30 mm, measured perpendicularly to the respective direction of extent in the individual segment.

FIG. 1 also shows an embodiment in which the groove width B is formed so that the width B increases axially from the inside outward toward the tire shoulder along the extent of the respective diagonal groove 5 or 6, wherein, for example, the minimum width of each diagonal groove 5 or 6 is B=15 mm and the maximum width is B=20 mm.

FIG. 2 also shows an embodiment with reference to a diagonal groove 6, in which the diagonal grooves 5 and 6 are each formed, on both sides of the groove base 14, with groove walls 15 and 16, respectively, which each form the flank delimiting the adjoining profile block element—here profile block element 4. In this case, as illustrated in FIG. 2, the groove walls 15 and 16 can be formed so as to enclose an angle of inclination with respect to the radial direction R in the respective segment in section planes perpendicular to the extent of the diagonal groove, wherein the selected angle of inclination δ of groove wall 15 in one embodiment is smaller than the angle of inclination ε of groove wall 16.

As can be seen in FIG. 1, each diagonal groove 5 opens into diagonal groove 6 at the axial position of the tip 7 of profile block element 3, which adjoins diagonal groove 5, at the axial distance (2a) from the end of extent of diagonal groove 6, the end being formed by the tip 8 of profile block element 4 and facing profile block row 2. Likewise, each diagonal groove 6 opens into diagonal groove 5 at the axial position of the tip 8 of profile block element 4, which adjoins the diagonal groove 6, at the axial distance (2a) from the end of extent of diagonal groove 5, the end being formed in the axial position of the by the tip 7 of profile block element 3 and facing profile block row 1.

Thus, the respective ends of extent of diagonal grooves 6 and 5, the ends each facing the other profile block row, are arranged offset with respect to one another both in the axial direction A of the pneumatic vehicle tire and in the circumferential direction U of the pneumatic vehicle tire.

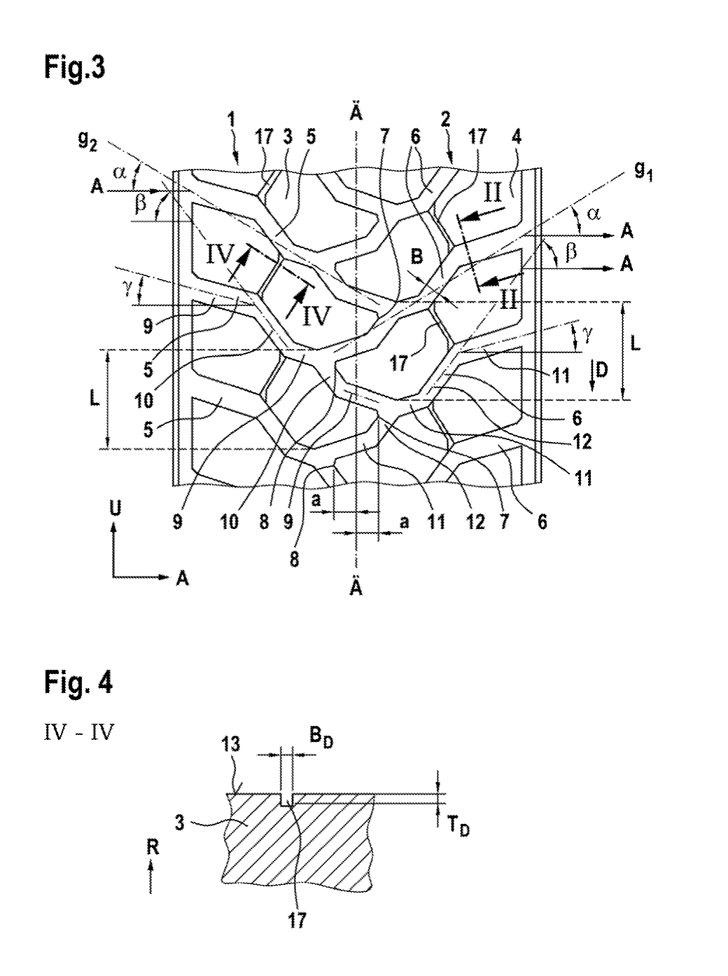

FIGS. 3 and 4 show another embodiment, in which fine decorative grooves 17 are additionally formed in the radially outer surface 13 only in profile block elements 3 and 4, the decorative grooves extending through the respective profile block element 3 and 4 when viewed in the circumferential direction U of the pneumatic vehicle tire and opening into the two diagonal grooves 5 and 6 delimiting the respective profile block elements 3 and 4. Here, the decorative grooves are formed with a depth T_{D} and a width B_{D}, measured in the radially outer surface 13, where T_{D}=3 mm and B_{D}=5 mm. In this case—as can be seen in FIG. 3—along their extent from diagonal groove 5 to diagonal groove 5, the decorative grooves 17 are aligned with a main direction of extent, the directional component of which in the circumferential direction U is greater than the directional component in the axial direction A. In this case, the decorative grooves 17 in profile block row 4 are formed, along their extent, with a direction of inclination which is opposite to the direction of inclination of the main direction of extent g₁ of the diagonal grooves 6. Likewise, the direction of inclination of the decorative grooves 17 of profile block 3 is here formed, along their extent, with a direction of inclination which is opposite to the direction of inclination of the main direction of extent g₂ of the diagonal grooves 5.

In one embodiment, the pneumatic commercial vehicle tire is a pneumatic commercial vehicle tire with a tread width of 240 mm to 280 mm, measured in the axial direction A.

In one embodiment, the pneumatic commercial vehicle tire is a pneumatic commercial vehicle tire of dimensions 315/80R22.5. In another embodiment, the pneumatic commercial vehicle tire is a pneumatic commercial vehicle tire of dimensions 295/80R22.5. In another embodiment, the pneumatic commercial vehicle tire is a pneumatic commercial vehicle tire of dimensions 13R22.5.

It is understood that the foregoing description is that of the preferred embodiments of the invention and that various changes and modifications may be made thereto without departing from the spirit and scope of the invention as defined in the appended claims.

### LIST OF REFERENCE SIGNS

### Part of the Specification

1 Profile block row
2 Profile block row
3 Profile block element
4 Profile block element
5 Diagonal groove
6 7 Diagonal groove
7 Tip
8 Tip
9 First segment
10 Second segment
11 First segment
12 Second segment
13 Radially outer surface
14 Groove base
15 Groove wall
16 Groove wall
17 Decorative groove

What is claimed is:

1. A rotationally directional tread profile of a tire of a commercial vehicle, the tire defining an axial direction (A) and the tread profile comprising:
the tread profile being divided into first and second parts in the axial direction (A) of the tire;
two axially adjacent profile block rows, each of which is formed from profile block elements that are arranged one behind the other over the circumference of the tire and are separated from one another by inclined grooves and thereby form a respective axial part of the extent of the tread profile;
the inclined grooves of one profile block row being designed so as to slope along the axial extent of the inclined grooves through the profile block row, starting from the other profile block row, such that the main direction of extent of the inclined grooves forms an angle α of inclination relative to the axial direction (A);
the inclined groove of one of the profile block rows having a direction of inclination which is oriented oppositely to that of the inclined grooves of the other one of the profile block rows when viewed in the circumferential direction (U) and the angle α of inclination of the inclined grooves of each of the profile block rows is formed such that the angle α lies in a range of 25°≤α≤35°; and,
the inclined grooves of one of the profile block rows being formed along the axial extent of the inclined grooves through the respective profile block row, starting from the other profile block row, such that first and second segments are formed which are arranged one behind the other in an alternating manner, wherein, along the extent of the inclined grooves, the inclined grooves each form an angle γ of inclination, wherein the angle γ lies in a range of 10°≤γ≤α, with respect to the axial direction (A) in the first segments and an angle β of inclination, wherein α≤β≤60°, with respect to the axial direction (A) in the second segments.

2. The tread profile of claim 1, wherein the beginning of extent of the inclined grooves of the first profile block row, the beginning being directed toward the second profile block row, is for each arranged offset in the circumferential direction (U) with respect to the position of the beginning of extent of the inclined grooves of the second profile block row, the beginning being directed toward the first profile block row.

3. A pneumatic vehicle tire of a commercial vehicle, the tire defining an axial direction (A) and comprising:
a rotationally directional tread profile divided into first and second parts in the axial direction (A) of the tire;
two axially adjacent profile block rows, each of which is formed from profile block elements that are arranged one behind the other over the circumference of the tire and are separated from one another by inclined grooves and thereby form a respective axial part of the extent of the tread profile;
the inclined grooves of one profile block row being designed so as to slope along the axial extent of the inclined grooves through the profile block row, starting from the other profile block row, such that the main direction of extent of the inclined grooves forms an angle α of inclination relative to the axial direction (A);
the inclined groove of one of the profile block rows having a direction of inclination which is oriented oppositely to that of the inclined grooves of the other one of the profile block rows when viewed in the circumferential direction (U) and the angle α of inclination of the inclined grooves of each of the profile block rows is formed such that the angle α lies in a range of 25°≤α≤35°;
the inclined grooves of one of the profile block rows being formed along the axial extent of the inclined grooves through the respective profile block row, starting from the other profile block row, such that first and second segments are formed which are arranged one behind the other in an alternating manner, wherein, along the extent of the inclined grooves, the inclined grooves each form an angle γ of inclination, wherein the angle γ lies in a range of 10°≤γ≤α, with respect to the axial direction (A) in the first segments and an angle β of inclination, wherein α≤β≤60°, with respect to the axial direction (A) in the second segments; and,
the profile block elements of the first profile block row being each delimited in the circumferential direction (U) by two successive inclined grooves of the first profile block row and, between the two inclined grooves, being delimited in the direction of the second profile block row by a segment of a diagonal groove of the second profile block row, and wherein the profile block elements of the second profile block row are each delimited in the circumferential direction (U) by two successive inclined grooves of the second profile block row and, between the two inclined grooves, are delimited in the direction of the first profile block row by a segment of an inclined groove of the first profile block row.

4. The pneumatic vehicle tire of claim 3, wherein the inclined grooves of one profile block row are each formed with a first segment at the beginning of extent of the inclined grooves which faces the other profile block row.

5. The pneumatic vehicle tire of claim 3, wherein the inclined grooves of one profile block row are each formed with a first segment at that end of extent of the diagonal grooves which faces away from the other profile block row, the end being formed in a tire shoulder.

6. The pneumatic vehicle tire of claim 3, wherein the inclined grooves have an uneven number of segments formed from first and second segments along the extent of the inclined grooves.

7. The pneumatic vehicle tire of claim 3, wherein the inclined grooves have four to eight segments formed from first and second segments along the extent of the inclined grooves.

8. The pneumatic vehicle tire of claim 3, wherein the profile block elements of one profile block row are each extended axially inward, beyond the equatorial plane Ä-Ä of the tire, toward the other profile block row in the axial direction (A), in each case starting from the tire shoulder, and end there.
